(19) United States
(12) Patent Application Publication
(10) Pub. No.: US 2016/0347365 A1
(43) Pub. Date: Dec. 1, 2016

(54) METHOD AND DEVICE FOR SUPPORTING A DRIVING MANEUVER OF A MOTOR VEHICLE

(71) Applicant: FORD GLOBAL TECHNOLOGIES, LLC, Dearborn, MI (US)

(72) Inventors: Tom RAMAKERS, Reinbach (DE); Nadja WYSIETZKI, Koeln NRW (DE)

(21) Appl. No.: 15/166,921

(22) Filed: May 27, 2016

(30) Foreign Application Priority Data
May 28, 2015 (DE) 10 2015 209 757.9

(51) Int. Cl. B62D 15/02; G01S 19/13

(52) U.S. Cl. CPC B62D 15/025; B62D 15/027; G01S 19/13

(57) ABSTRACT

The invention concerns a method and a device for supporting a driving maneuver of a motor vehicle. With a method according to the invention for supporting a driving maneuver of a motor vehicle, said support is carried out based on the sensor-based detection of the surroundings of the vehicle using at least one ultrasonic sensor, wherein the sensitivity of said at least one ultrasonic sensor is adjusted based on input data characteristic of the current condition of the surface beneath the motor vehicle, not on input data provided by the ultrasonic sensor.

### CROSS-REFERENCE TO RELATED APPLICATION

This application claims foreign priority benefits under 35 U.S.C. §119(a)-(d) to DE 10 2015 209 757.9, filed May 28, 2015, which is hereby incorporated by reference in its entirety.

### TECHNICAL FIELD

The present invention concerns a method and a device for supporting a driving maneuver of a motor vehicle.

### BACKGROUND

In current and future methods for parking assistance, the vehicle is controlled along a previously planned path of motion (trajectory) during the parking process. The planning of said path of motion or trajectory is carried out based on the sensor-based detection of the surroundings of the vehicle using ultrasonic sensors.

During this, in practice the problem occurs that as a rule different parking scenarios also require adjustment of the sensitivity of the ultrasonic sensors. Whereas in some scenarios, such as with the necessarily sensor-based detection of relatively small objects or obstacles, such as for example poles or posts, a relatively high sensitivity of the ultrasonic sensors is necessary, in other scenarios (such as for example when driving over gravel, aggregate or cobbles) a relatively low sensitivity of the ultrasonic sensors is desirable, because otherwise (i.e. with a high sensitivity of the ultrasonic sensors when travelling over gravel or cobbles) pebbles or cobble fragments can be interpreted as objects or obstacles to be detected. In practice, for example a compromise regarding the sensitivity adjustment of the ultrasonic sensors between the different possible scenarios is selected.

Inter alia, a method and a device for operating a radar sensor arrangement are known from DE 101 24 909 A1, wherein a number of adjacent, essentially mutually synchronized individual sensors are used for determining the position of a target object, for example of a pole or a wall.

Inter alia, an obstacle detection device, in particular a parking aid, is known from DE 10 2004 005 960 A1, which comprises a sensor device for transmitting a transmission signal and for receiving an echo signal that represents the transmission signal reflected at an obstacle. Furthermore, an analyzer for analyzing the received echo signal with respect to the presence of the obstacle as well as an adjustment device for automatic readjustment of the sensor device and/or the analyzer such that the analyzer detects the obstacle with a desired sensitivity are provided. Here the adjustment device carries out the readjustment in such a manner that it first sets a suboptimal (i.e. too sensitive) setting, in order to then subsequently automatically successively change the set sensitivity until the desired optimal sensitivity is achieved. In each successive readjustment step, a transmission signal is transmitted by the sensor device in each case, and the component of the transmission signal for example reflected from the road surface is received as the echo signal by the analyzer.

Inter alia, a sensor system for determining a distance is known from EP 1 314 047 B1, which comprises a sensor unit and an amplification unit, wherein the sensor unit operates in different detection ranges during a detection cycle, wherein at least one sensor signal is produced depending on the detection range. The amplification unit amplifies the sensor signal depending on the value of an amplification parameter.

### SUMMARY

It is an object of the present invention to provide a method and a device for supporting a driving maneuver, wherein a more reliable detection or assessment of the surroundings of the vehicle is made possible.

This object is achieved by the method according to the features of the independent claim 1 or the device according to the features of the further independent claim 7.

With a method according to the invention for supporting a driving maneuver of a motor vehicle, said support is carried out based on the sensor-based detection of the surroundings of the vehicle using at least one ultrasonic sensor, wherein the sensitivity of said at least one ultrasonic sensor is adjusted based on input data characteristic of the current surface conditions for the motor vehicle, not on the input data provided by the ultrasonic sensor.

According to one embodiment, the input data comprise GPS data of a GPS sensor.

According to one embodiment, the input data comprise sensor data of at least one wheel sensor of the motor vehicle.

According to one embodiment, the input data comprise camera data of a camera sensor of the motor vehicle.

According to one embodiment, the sensitivity of the at least one ultrasonic sensor is reduced with increasing roughness of the ground beneath the motor vehicle.

According to one embodiment, the driving maneuver is a parking maneuver or a turning maneuver.

The invention further concerns a device for supporting a driving maneuver of a motor vehicle, wherein the device is configured to carry out a method with the above features. Reference is made to the above implementations in combination with the method according to the invention for advantages and preferred embodiments of the device.

Further embodiments of the invention are to be found in the description as well as in the dependent claims.

The invention is described below using an exemplary embodiment with reference to the accompanying figure.

### BRIEF DESCRIPTION OF THE DRAWINGS

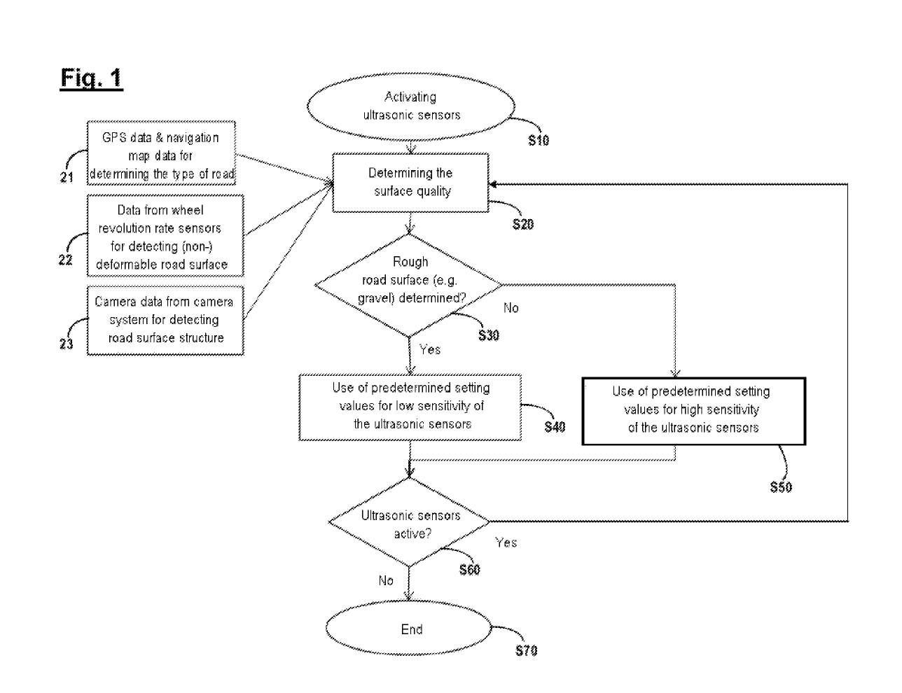

The single FIG. 1 is used to describe a method according to the invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A typical process of the method according to the invention is described below using an exemplary embodiment with reference to the flow chart of FIG. 1.

According to FIG. 1, activation of the ultrasonic sensors is carried out in a first step S10 (wherein said activation can be carried out by manual input on the part of the driver or even automatically).

In a subsequent step S20, determination of the condition of the surface under the motor vehicle, i.e. the ground surface or the road properties of the road on which the motor vehicle is currently travelling, is carried out. Said determination is carried out according to FIG. 1 while taking into account input data 21, 22 and 23.

Specifically, the input data 21 comprise GPS data as well as navigation maps, which are suitable for determination or assessment of the type of road or the condition of the surface beneath the motor vehicle. The input data 22 comprise data of wheel sensors or wheel revolution rate sensors, wherein such data in particular enable conclusions to be drawn regarding the deformability (or non-deformability) of the road on which the motor vehicle is currently travelling. The input data 23 comprise camera data of a camera system, wherein said camera data are suitable for characterizing the surface structure or surface quality.

In a subsequent step S30, a check is carried out as to whether the surface is rough (for example bumpy)—for example owing to the motor vehicle currently travelling on rough terrain. If this is the case, predetermined setting values of the ultrasonic sensors according to a relatively low sensitivity are selected in the step S40. Otherwise, predetermined setting values for a relatively higher sensitivity of the ultrasonic sensors are selected in the step S50. The invention is thus based in particular on the concept of using GPS, camera and/or wheel sensor data for determining the condition of a surface beneath a motor vehicle.

Following suitable setting of the sensitivity of the ultrasonic sensors, a check is carried out in the step S60 as to whether the ultrasonic sensors continue to be active. If this is the case, a return to step S20 is carried out, i.e. a re-determination of the surface conditions. Otherwise, the method ends (step S70).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for supporting a driving maneuver of a motor vehicle, wherein said support is carried out based on the sensor-based detection of the surroundings of the vehicle using at least one ultrasonic sensor, wherein the sensitivity of said at least one ultrasonic sensor is adjusted based on input data characteristic of the current surface conditions for the motor vehicle, not based on input data provided by the ultrasonic sensor.

2. The method as claimed in claim 1, wherein said input data comprise GPS data of a GPS sensor.

3. The method as claimed in claim 1, wherein said input data comprise sensor data of at least one wheel sensor of the motor vehicle.

4. The method as claimed in claim 1, wherein said input data comprise camera data of a camera sensor of the motor vehicle.

5. The method as claimed in claim 1, wherein the sensitivity of the at least one ultrasonic sensor is reduced with increasing roughness of the surface beneath the motor vehicle.

6. The method as claimed in claim 1, wherein the driving maneuver is a parking maneuver or a turning maneuver.

7. A device for supporting a driving maneuver of a motor vehicle, wherein said support can be carried out based on the sensor-based detection of the surroundings of the vehicle using at least one ultrasonic sensor, wherein the device is configured to carry out the method as claimed in claim 1.
